(19) United States
(12) Patent Application Publication
(10) Pub. No.: US 2015/0246547 A1
(43) Pub. Date: Sep. 3, 2015

(54) PRINTHEAD NOZZLE RECOVERY

(71) Applicant: Hewlett-Packard Industrial Printing Ltd., Fort Collins, CO (US)

(72) Inventors: Semion Gengrinovich, Ramat Gan (IL); Dan Bavli, Netanya (IL); Ehud Eliasaf, Netanya (IL)

(21) Appl. No.: 14/625,205

(22) Filed: Feb. 18, 2015

(30) Foreign Application Priority Data
Feb. 28, 2014 (EP) 14275033.0

(51) Int. Cl. B41J 2/165

(52) U.S. Cl. CPC B41J 2/16579

(57) ABSTRACT

A printhead recovery system includes at least one printhead and a control module. The printhead includes a respective set of nozzles. The control module activates a nozzle recovery routine including ejecting fluid through nozzles adjacent to a malfunctioning nozzle to create a positive pressure proximate to the malfunctioning nozzle from outside of the at least one printhead.

### BACKGROUND

Printhead recovery system may include a printhead and a maintenance member to clean the printhead. The printhead may include nozzles in which drops of printing fluid are ejected there from to media during a firing state. During the firing state, printing fluid puddles may accumulate on an exterior nozzle surface of the respective inkjet printhead. Periodically, the maintenance member may engage and clean the printhead.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram illustrating a printhead recovery system according to an example.

FIG. 2. Is a schematic view illustrating a printhead recovery system according to an example.

FIGS. 3A-3C are schematic views of nozzles of a printhead of the printhead recovery system of FIG. 2 according to examples.

FIG. 4 is a flowchart illustrating a printhead recovery method according to an example.

FIG. 5 is a block diagram illustrating a computing device such as a printhead recovery system including a processor and a non-transitory, computer-readable storage medium to store instructions to operate the printhead recovery system according to an example.

### DETAILED DESCRIPTION

Printhead recovery systems may include at least one printhead and a maintenance member to clean the printhead. The printhead may be an inkjet printhead and include nozzles in which drops of fluid such as printing fluid are ejected there from to media during a firing state. Overtime, printing fluid puddles may accumulate on an exterior nozzle surface of the respective inkjet printhead and form obstructions with respect to the nozzles. At times, the maintenance member such as a wiper and/or blade may physically contact and clean the printhead. However, certain nozzles may become and/or remain in a malfunction state by losing its prime and not maintain a fluid meniscus therein resulting in an inability to eject fluid therefrom. The wiper and/or blade may increase the cost of the printhead recovery system and delay the printing of images on media. Also, the wiper and/or blade may not be able to correct the de-primed condition of the respective malfunctioning nozzles. Thus, image degradation and a decrease in throughput of a printing system may result.

In examples, a printhead recovery system includes at least one printhead and a control module. The printhead includes a respective set of nozzles. The control module activates a nozzle recovery routine including ejecting fluid through nozzles adjacent to a malfunctioning nozzle to create a positive pressure proximate to the malfunctioning nozzle from outside of the at least one printhead. The nozzle recovery routine may be activated at a predetermined time. For example, activation of the nozzle recovery routine may be selectively done at times not to delay printing on the media and, thus, does not decrease the throughput of the printing system. Accordingly, activation of the nozzle recovery routine may correct the malfunctioning nozzles by priming them without increasing the cost of the printhead recovery system and delaying printing of images on media. Thus, image degradation and a decrease in throughput of the printing system may be reduced.

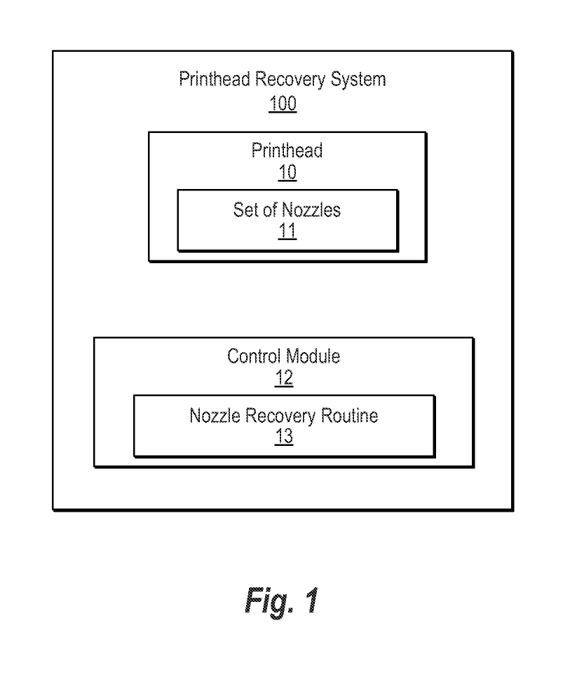

FIG. 1 is a block diagram illustrating a printhead recovery system according to an example. Referring to FIG. 1, in some examples, a printhead recovery system 100 includes at least one printhead 10 and a control module 12. The printhead 10 includes a respective set of nozzles 11. For example, upon the printhead 10 receiving corresponding firing signals, fluid such as printing fluid therein may be ejected through the nozzles 11 onto a media. In some examples, the printhead 10 may be in the form of a piezoelectric inkjet printhead. That is, the printhead 10 may include piezoelectric actuators to receive firing signals to cause movement of the piezoelectric actuators. Such movement may cause sufficient pressure to the printing fluid within the printhead 10 to eject the printing fluid through corresponding nozzles 11 to the media, and the like. In some examples, the printhead recovery system 100 may be in a form of a printing system such as an inkjet printer and include a plurality of inkjet printheads 10.

At times, certain nozzles may malfunction resulting in an inability to eject fluid therefrom. That is, a respective nozzle may lose its prime and, thus, not maintain its fluid meniscus. The control module 12 activates a nozzle recovery routine 13, for example, in order to re-prime the malfunctioning nozzle to enable it to eject fluid therefrom. The nozzle recovery routine 13 includes ejecting fluid such as printing fluid through nozzles 11 including nozzles adjacent to a malfunctioning nozzle to create a positive pressure proximate to the malfunctioning nozzle from outside of the printhead 10. A malfunctioning nozzle corresponds to a nozzle in which fluid does not eject therefrom in response to a corresponding firing signal being received by the printhead. In some examples, positive pressure may be created outside a respective nozzle to rebuild the fluid meniscus in the malfunctioning nozzle and cause fluid to be able to flow there through.

Referring to FIG. 1, in some examples, the nozzle recovery routine 13 is activated at a predetermined time. For example, the predetermined time may be during periods when the printhead 10 is not in the process of forming an image on the media. The control module 12 may be implemented in hardware, software including firmware, or combinations thereof. The firmware, for example, may be stored in memory and executed by a suitable instruction-execution system. If implemented in hardware, as in an alternative example, the control module 12 may be implemented with any or a combination of technologies which are well known in the art (for example, discrete-logic circuits, application-specific integrated circuits (ASICs), programmable-gate arrays (PGAs), field-programmable gate arrays (FPGAs)), and/or other later developed technologies. In other examples, the control module may be implemented in a combination of software and data executed and stored under the control of a computing device.

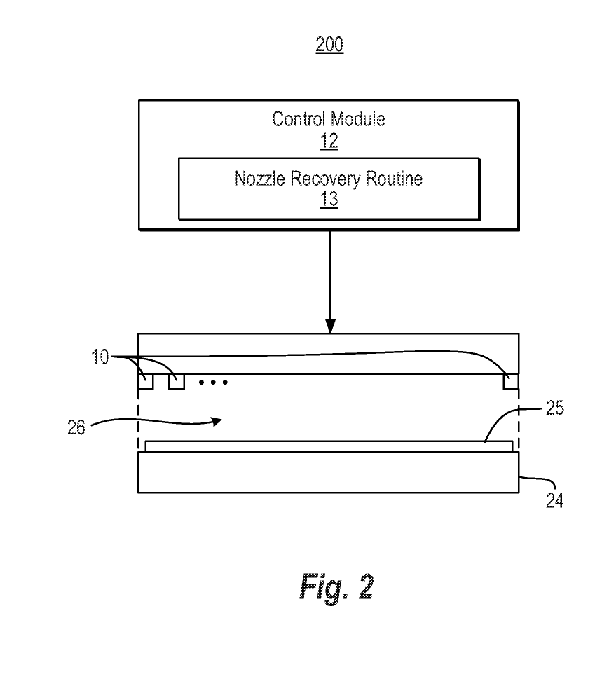

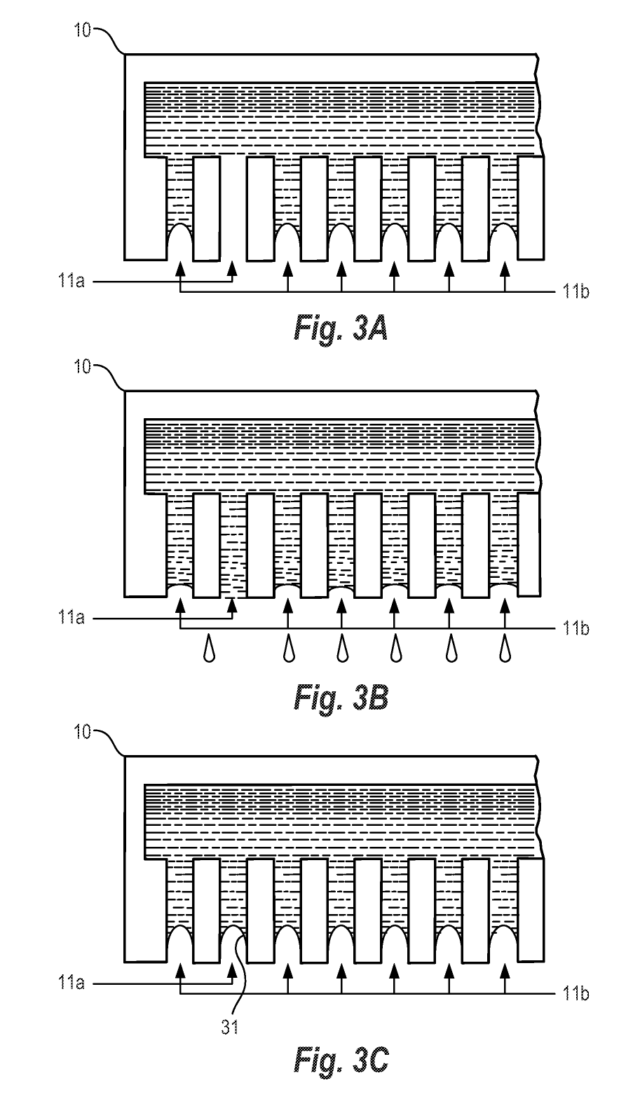

FIG. 2. is a schematic view illustrating a printhead recovery system according to an example. FIGS. 3A-3C are schematic views of nozzles of a printhead of the printhead recovery system of FIG. 2 according to examples. The printhead recovery system 200 may include the printhead 10 and the control module 12 as previously discussed with respect to the printhead recovery system 100 of FIG. 1. Referring to FIG. 2, in some examples, the printhead recovery system 200 may also include a movable media support member 24. The movable media support member 24 may transport media 25 to a print zone 26. For example, the movable media support member 24 may be a table, platen, belt, and the like. The print zone 26, for example, is an area adjacent and opposite to the printhead 10 to receive media 25 to be printing on by the printhead 10.

Referring to FIG. 2, in some examples, the predetermined time is during at least one of a loading of media 25 to be printed on into a print zone 26 and the unloading of the media 25 printed on from the print zone 26. For example, the movable media support member 24 may move the media 25 into a print zone 26 to be printed on and/or move the printed media from the print zone 26 after being printed on. In some examples, the predetermined time may be during at least one of an acceleration and deceleration of the media support member 24. That is, in some examples, activation of the nozzle recovery routine 13 is done at times not to delay printing on the media 25 and, thus, does not decrease the throughput of the printing system.

Referring to FIG. 3A, at times, a respective nozzle 11a may malfunction resulting in an inability to eject fluid therefrom. That is, the malfunctioning nozzle 11a may lose its prime and, thus, not maintain its fluid meniscus. Referring to FIG. 3B, the control module 12 activates a nozzle recovery routine 13, for example, in order to re-prime the malfunctioning nozzle 11a to enable it to eject fluid therefrom. For example, the nozzle recovery routine 13 includes ejecting fluid such as printing fluid through nozzles 11b including adjacent nozzles to a malfunctioning nozzle 11a to create a positive pressure proximate to the malfunctioning nozzle 11a from outside of the printhead 10. A malfunctioning nozzle 11a corresponds to a nozzle in which fluid does not eject therefrom in response to a corresponding firing signal being received by the printhead 10.

Referring to FIG. 3B, in some examples, a single activation of the nozzle recovery routine 13 by the control module 12 may correspond to the firing of a respective set of nozzles 11b for a predetermined period of time. During a single activation of the nozzle recovery routine 13, firing signals may be initiated to correspond with ejecting of fluid such as printing fluid through nozzles 11b including nozzles adjacent to a respective malfunctioning nozzle 11a of the at least one printhead 10 as illustrated in FIG. 3B. The ejection of fluid through adjacent nozzles may cause a sufficient amount of positive pressure proximate to the malfunctioning nozzle 11a to cause fluid to flow through the malfunctioning nozzle 11a. For example, creation of a sufficient hydraulic cross talk condition with respective nozzles 11b of the printhead 10 may provide the sufficient amount of positive pressure proximate to the malfunctioning nozzle 11a in order to reestablish its fluid meniscus 31. A hydraulic cross talk condition corresponds to a state of a printhead 10 in which adjacent nozzles to a respective nozzle are jetted simultaneously without a temporal shift. For example, at least adjacent nozzles on each side of a malfunctioning nozzle 11a jets to create pressure above the malfunctioning nozzle 10a to re-prime it.

Referring to FIG. 3B, during a single activation of the nozzle recovery routine 13, firing signals may be initiated to correspond with ejecting of fluid such as printing fluid through all nozzles 11b of the at least one printhead 10. The ejection of fluid through all nozzles 11b may cause a sufficient amount of positive pressure proximate to the malfunctioning nozzle 11a to cause fluid to flow through the malfunctioning nozzle 11a and the fluid meniscus 31 of the previously malfunctioning nozzle 11a to be reestablished as illustrated in FIG. 3C. That is, creation of a hydraulic cross talk condition

Referring to FIGS. 3A-3C, in some examples, a duration of a single activation of the nozzle recovery routine 13, for example, is in a range of time of 3 to 7 seconds. Additionally, in some examples, an amount of the fluid such as printing fluid used for a single activation of the nozzle recovery routine 13 is less than 0.5 cubic centimeters to minimize printing fluid waste. Further, a single activation of the nozzle recovery routine 13 may create an amount of pressure at the malfunctioning nozzle in a range of 0.3-0.5 bar. For example, the amount of pressure may be strong enough to correct the malfunctioning state of the malfunctioning nozzle 11a and, yet, weak enough not to negatively impact flight paths of printing fluid ejected from other proximate nozzles 11b.

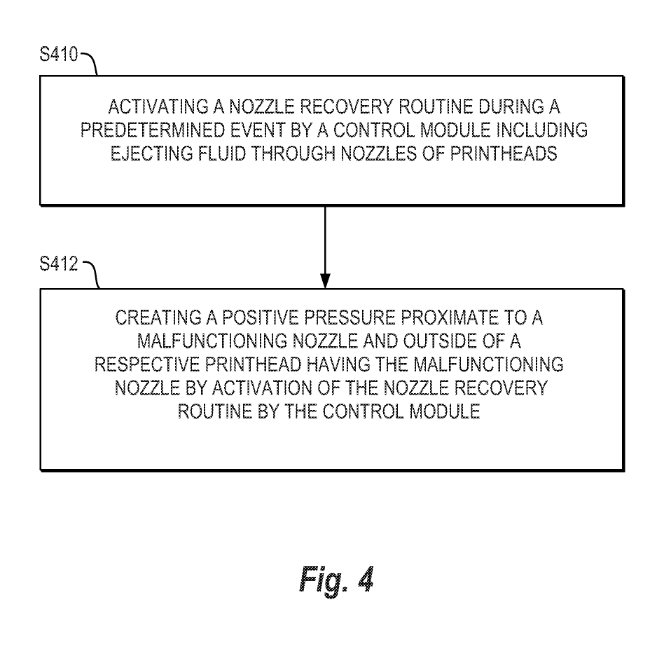

FIG. 4 is a flowchart illustrating a printhead recovery method according to an example. In some examples, the modules, assemblies, and the like, previously discussed with respect to FIGS. 1-3C may be used to implement the printhead recovery method of FIG. 4. Referring to FIG. 4, in block S410, a nozzle recovery routine is activated during a predetermined event by a control module including ejecting fluid through nozzles of printheads. In some examples, the predetermined event may include at least one of a media loading stage, a media unloading stage, an acceleration of a movable media support member to transport media to a print zone, and a deceleration of the movable media support member.

In some examples, firing signals may be initiated to correspond with ejecting of fluid such as printing fluid through nozzles including adjacent nozzles of the printheads. In some examples, firing signals may be initiated to correspond with ejecting of fluid such as printing fluid through all nozzles of the printheads. In some examples, a duration of a single activation of the nozzle recovery routine, for example, is in a range of time of 3 to 7 seconds. Additionally, in some examples, an amount of fluid used during a single activation of the nozzle recovery routine is less than 0.5 cubic centimeters. In block S412, a positive pressure in a range of 0.3-0.5 bar is created proximate to a malfunctioning nozzle and outside of a respective printhead having the malfunctioning nozzle by activation of the nozzle recovery routine by the control module. For example, the amount of pressure may be strong enough to correct the malfunctioning state of the malfunctioning nozzle and, yet, weak enough not to negatively impact flight paths of printing fluid ejected from other proximate nozzle.

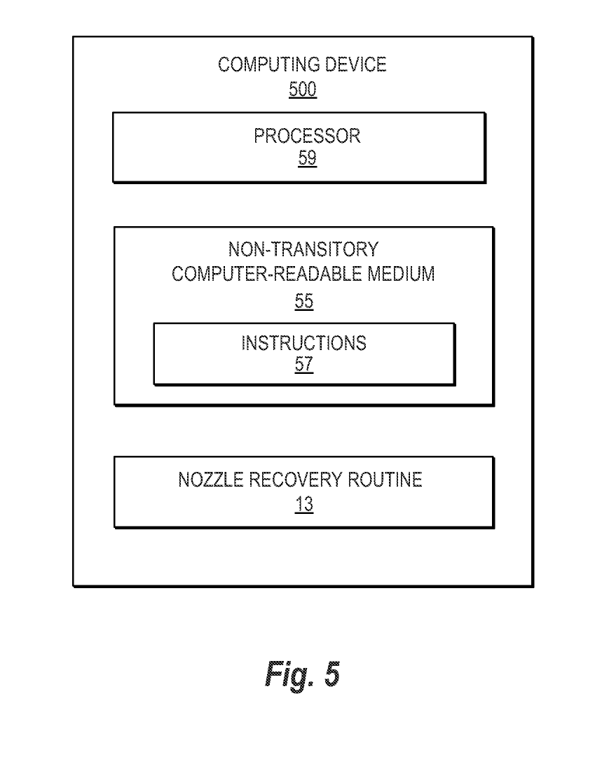

FIG. 5 is a block diagram illustrating a computing device such as a printhead recovery system including a processor and a non-transitory, computer-readable storage medium to store instructions to operate the printhead recovery system according to an example. Referring to FIG. 5, in some examples, the non-transitory, computer-readable storage medium 55 may be included in a computing device 500 such as a printhead recovery system including a nozzle recovery routine 13. In some examples, the non-transitory, computer-readable storage medium 55 may be implemented in whole or in part as instructions 57 such as computer-implemented instructions stored in the computing device locally or remotely, for example, in a server or a host computing device.

Referring to FIG. 5, in some examples, the non-transitory, computer-readable storage medium 55 may correspond to a storage device that stores instructions 57, such as computer-implemented instructions and/or programming code, and the like. For example, the non-transitory, computer-readable storage medium 55 may include a non-volatile memory, a volatile memory, and/or a storage device. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM).

Referring to FIG. 5, examples of storage devices include, but are not limited to, hard disk drives, compact disc drives, digital versatile disc drives, optical drives, and flash memory devices. In some examples, the non-transitory, computer-readable storage medium 55 may even be paper or another suitable medium upon which the instructions 57 are printed, as the instructions 57 can be electronically captured, via, for instance, optical scanning of the paper or other medium, then compiled, interpreted or otherwise processed in a single manner, if necessary, and then stored therein. A processor 59 generally retrieves and executes the instructions 57 stored in the non-transitory, computer-readable storage medium 55, for example, to operate a computing device 500 such as a printhead recovery system in accordance with an example. In an example, the non-transitory, computer-readable storage medium 55 can be accessed by the processor 59.

It is to be understood that the flowchart of FIG. 4 illustrates architecture, functionality, and/or operation of examples of the present disclosure. If embodied in software, each block may represent a module, segment, or portion of code that includes one or more executable instructions to implement the specified logical function(s). If embodied in hardware, each block may represent a circuit or a number of interconnected circuits to implement the specified logical function(s). Although the flowchart of FIG. 4 illustrates a specific order of execution, the order of execution may differ from that which is depicted. For example, the order of execution of two or more blocks may be rearranged relative to the order illustrated. Also, two or more blocks illustrated in succession in FIG. 4 may be executed concurrently or with partial concurrence. All such variations are within the scope of the present disclosure.

The present disclosure has been described using non-limiting detailed descriptions of examples thereof that are not intended to limit the scope of the general inventive concept. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are replaceable by equivalents, which perform the same function, even if the structure or acts are different, as known in the art. Therefore, the scope of the general inventive concept is limited only by the elements and limitations as used in the claims.

What is claimed is:

1. A printhead recovery system, comprising:
at least one printhead including a respective set of nozzles; and
a control module to activate a nozzle recovery routine including ejecting fluid through nozzles adjacent to a malfunctioning nozzle to create a positive pressure proximate to the malfunctioning nozzle from outside of the at least one printhead, and wherein the nozzle recovery routine is activated at a predetermined time.

2. The printhead recovery system of claim 1, wherein the malfunctioning nozzle corresponds to fluid not being ejected therefrom in response to a corresponding firing signal.

3. The printhead recovery system of claim 1, wherein the predetermined time is during at least one of a loading of media to be printed on into a print zone and the unloading of the media printed on from the print zone.

4. The printhead recovery system of claim 1, further comprising:
a movable media support member to transport media to a print zone; and
wherein the predetermined time is during at least one of an acceleration and deceleration of the media support member.

5. The printhead recovery system of claim 1, wherein a duration of a single activation of the nozzle recovery routine is in a range of time of 3 to 7 seconds.

6. The printhead recovery system of claim 1, wherein an amount of the fluid used for a single activation of the nozzle recovery routine is less than 0.5 cubic centimeters.

7. The printhead recovery system of claim 1, wherein a single activation of the nozzle recovery routine creates an amount of pressure at the malfunctioning nozzle in a range of 0.3-0.5 bar.

8. The printhead recovery system of claim 1, wherein the activation of the nozzle recovery routine includes initiating firing signals to correspond with ejecting of fluid through all the nozzles of the at least one printhead.

9. A printhead recovery method, comprising:
activating a nozzle recovery routine during a predetermined event by a control module including ejecting fluid through nozzles of printheads; and
creating a positive pressure proximate to a malfunctioning nozzle and outside of a respective printhead having the malfunctioning nozzle by activation of the nozzle recovery routine by the control module.

10. The printhead recovery method of claim 9, wherein a duration of a single activation of the nozzle recovery routine is in a range of time of 3 to 7 seconds.

11. The printhead recovery method of claim 9, wherein an amount of fluid used during a single of the nozzle recovery routine less than 0.5 cubic centimeters.

12. The printhead recovery method of claim 9, wherein the predetermined event comprises at least one of a media loading stage, a media unloading stage, an acceleration of a movable media support member to transport media to a print zone, and a deceleration of the movable media support member.

13. The printhead recovery method of claim 9, wherein the activating a nozzle recovery routine including ejecting fluid through nozzles of printheads by a control module during at least one of a media loading stage and a media unloading stage further comprises:
initiating firing signals to correspond with ejecting of fluid through all nozzles of the printheads.

14. The printhead recovery method of claim 13, wherein the amount of pressure at the malfunctioning nozzle is in a range of 0.3-0.5 bar.

15. A non-transitory computer-readable storage medium having computer executable instructions stored thereon to perform a printhead recovery method, the instructions are executable by a processor to:
activate a nozzle recovery routine during at least one of a media loading stage in which media to be printed on is loaded into the print zone and a media unloading stage in which media printed on is unloaded from the print zone by a control module including ejecting fluid through adjacent nozzles of printheads; and
create a positive pressure proximate to a malfunctioning nozzle and outside of a respective printhead having the malfunctioning nozzle by activation of the nozzle recovery routine by the control module based in a range of 0.3-0.5 bar.
